(19) United States
(12) Patent Application Publication
(10) Pub. No.: US 2019/0021242 A1
(43) Pub. Date: Jan. 24, 2019

(54) Tornado Dissipating Device

(71) Applicant: Mun Hyeong Cho, Seoul (KR)

(72) Inventor: Mun Hyeong Cho, Seoul (KR)

(21) Appl. No.: 15/654,504

(22) Filed: Jul. 19, 2017

(51) Int. Cl. A01G 15/00

(52) U.S. Cl. CPC A01G 15/00

(57) ABSTRACT

Disclosed is a tornado dissipating device capable of weakening and dissipating a tornado to minimize human injuries and material damages.

### BACKGROUND OF THE INVENTION

### Field of the Invention

The present invention relates to a device capable of dissipating a tornado, and, more particularly, to a tornado dissipating device capable of weakening and dissipating a tornado to minimize human injuries and material damages.

### Background of the Related Art

A tornado is one of weather phenomenon.

The tornado is a rapidly rotating column of air that is in contact with a plain or sea and a cumulonimbus cloud, and is often referred to as a twister or cyclone.

A reason of occurrence of the tornado is definitively not established, but, according to research results, it is known that the tornado occurs when very warm and humid air rises under unstable atmosphere.

Specifically, the air within the cumulonimbus cloud which is a dense towering vertical cloud, like a mountain or big tower, is heated by a latent heat of the cumulonimbus cloud, creating powerful upward air currents. The risen air rotates slowly in the vicinity of a top of the cloud, and is gradually expanded toward a bottom to take on the appearance of a narrow funnel. Although the funnel may not extend all the way to the ground, if associated surface winds are greater than 64 km/h, the circulation is considered a tornado.

Tornadoes can be observed on every continent, except for the Antarctic, but the majority of tornadoes occur in the United States.

In the case of the Great Plains of the United States, it is known that the tornado occurs frequently when a warm and moist oceanic air mass from the Gulf of Mexico meets a cold and dry continental air mass from Rocky Mountain. An occurrence rate is high in the spring season, that is, in May 6 tornadoes occur on daily average. However, an occurrence rate is low in the winter season, that is, 0.5 tornadoes occur on daily average from December to January.

Tornadoes appear in many shapes and sizes, but the tornadoes are visible in the form of a funnel. A diameter ranges from 150 to 600 m on average, and the tornado moves at the speed of 40 to 80 km/hr.

In the case of the relatively weak tornadoes, the tornado does not exceed a travel range of 1 km. In the case of the strong tornadoes, it can travel up to hundreds of kilometers. An average travel range is about 10 km.

Such a tornado has a strong updraft around an outside of the vortex which can swirl up various things on the ground, like a vacuum cleaner.

Therefore, since the tornado strongly impacts on facilities on the ground with different intensity when the tornado is traveling along the ground, the tornado causes damage on the ground.

The tornado is generally ranged between F0 to F5 tornados by Fujita Scale, on the basis of damage caused by the tornado. In recent times, the scale for rating the strength of tornadoes is replaced in some countries by the updated Enhanced Fujita Scale, ranging from EF0 to EF5.

The weakest category EF0 of the Enhanced Fujita Scale has wind speed of 29 to 38 m/s which damages branches of trees and sign boards. EF1 has wind speed of 39 to 49 m/s which damages trees and windows. EF2 has wind speed of 50 to 60 m/s which destroys weak building or pulls up huge tree. EF3 has wind speed of 61 to 74 m/s which overturns a vehicle and destroys a building wall. EF4 has wind speed of 75 to 89 m/s which completely destroys a well-constructed and whole frame houses. And, EF5 has wind speed of more than 90 m/s which moves a car-sized structure by about 100 m or more and damages steel structures.

Meanwhile, the damages caused by the tornado include irreversible human injuries, as well as material damages which require for long restoration work.

Although it seeks for a solution to minimize the material damages and the human injuries caused by the strong vortex wind, such as a tornado, there is no satisfactory result so far.

### SUMMARY OF THE INVENTION

Therefore, the present invention has been made in view of the above problems, and an object of the present invention is to provide a tornado dissipating device capable of minimizing human injuries and material damages caused by tornado.

In order to achieve the above object, there is provided a tornado dissipating device including: an inlet portion that is formed in such a way that a width is gradually reduced from a front side to a rear side, and has at a front end thereof a first opening which communicates with an exterior; and an outlet portion of constant width that is formed to be extended from the rear side of the inlet portion and be gradually inclined in an upward direction toward a rear side, and has at a rear end thereof a second opening which communicates with the first opening and the exterior.

With the above configuration, the inlet portion is formed in such a way that the width is gradually reduced from the front side to the rear side, and has at the front end thereof the first opening which communicates with the exterior, and the outlet portion of the constant width is formed to be extended from the rear side of the inlet portion and has at the rear end thereof the second opening which communicates with the first opening and the exterior. Since the tornado is gradually dissipated due to the resistance generated by the contact between the tornado and the inner surface when the strong vortex wind travels from the first opening of the inlet portion to the outlet portion, so that the weakened wind is discharged from the second opening, thereby minimizing human injuries and material damages caused by the tornado.

Also, the inlet portion and the outlet portion are provided with the plurality of protrusions protruding from the inner surface. Since the tornado is gradually dissipated due to the resistance generated by the contact between the tornado and the protrusions when the strong vortex wind travels from the first opening of the inlet portion to the outlet portion, so that the weakened wind is discharged from the second opening, thereby minimizing human injuries and material damages caused by the tornado.

### BRIEF DESCRIPTION OF THE DRAWINGS

FIG. 1 is a perspective view illustrating an appearance of a tornado dissipating device according to an embodiment of the present invention.

FIG. 2 is a cross-sectional view illustrating a structure of the tornado dissipating device according to the embodiment of the present invention.

FIG. 3 is a view illustrating a fixed state of the tornado dissipating device according to the embodiment of the present invention.

FIG. 4 is a view illustrating an inflow of strong swirl wind into a first opening of the tornado dissipating device according to the embodiment of the present invention.

FIG. 5 is a view illustrating a weaken state of the strong swirl wind by an inlet portion of the tornado dissipating device according to the embodiment of the present invention.

FIG. 6 is a view illustrating discharge of the weakened wind through a second opening of the tornado dissipating device according to the embodiment of the present invention.

FIG. 7 is a view illustrating an example of protrusions which are provided on inlet and outlet portions of the tornado dissipating device according to the embodiment of the present invention.

FIG. 8 is a view illustrating one example of the protrusions which are provided on the inlet and outlet portions of the tornado dissipating device according to the embodiment of the present invention.

FIG. 9 is a view illustrating another example of the protrusions which are provided on the inlet and outlet portions of the tornado dissipating device according to the embodiment of the present invention.

### DETAILED DESCRIPTION OF THE PREFERRED EMBODIMENT

A tornado dissipating device according to preferred embodiments of the present invention will now be described in detail with reference to the accompanying drawings.

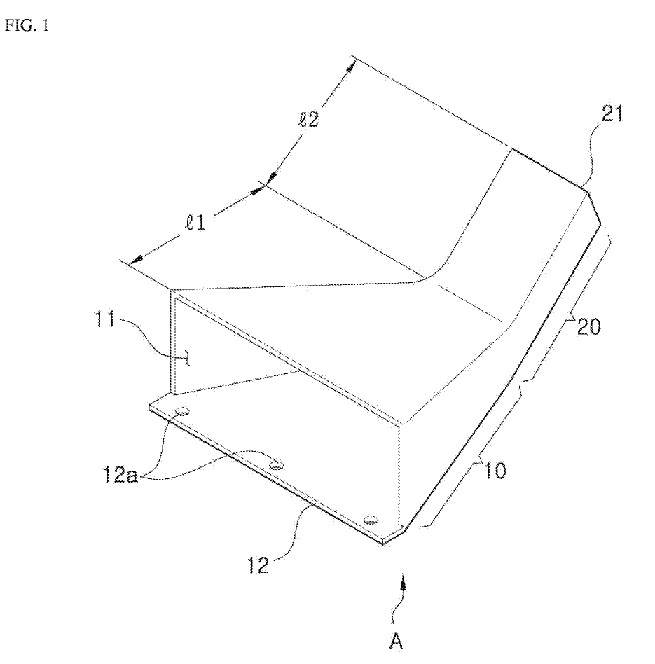

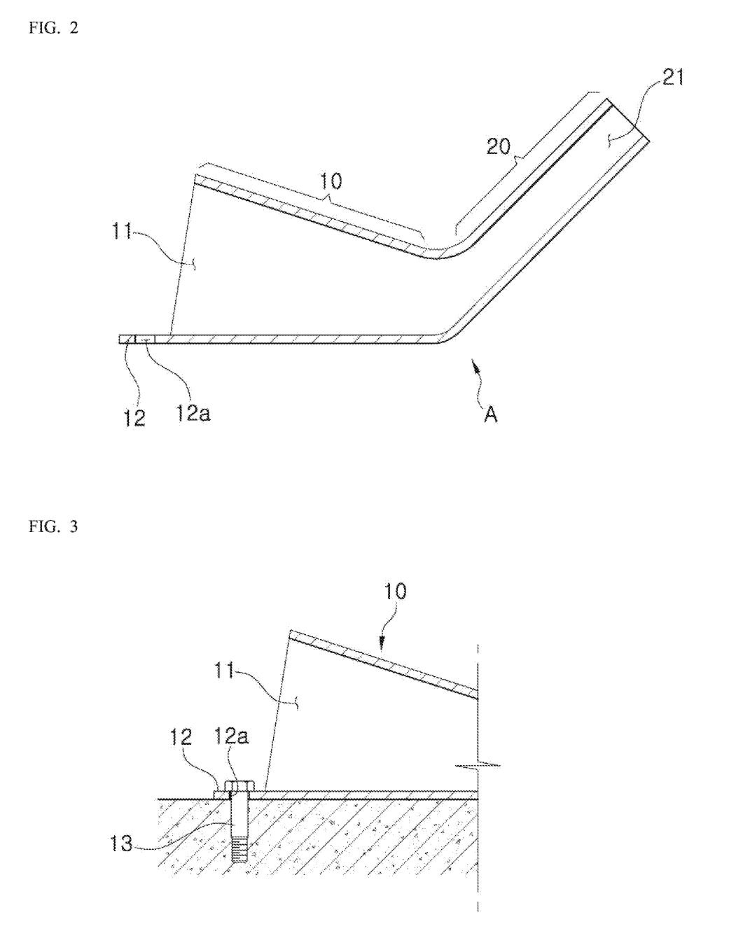

As illustrated in FIGS. 1 and 2, a tornado dissipating device A according to the present invention includes an inlet portion 10 and an outlet portion 20.

The inlet portion 10 is formed in such a way that its width is gradually decreased from a front side to a rear side, and has a first opening 11 which communicates with an exterior, at a front end thereof.

When tornado T enters the inlet portion 10 through the first opening 11, the tornado moves from the front side having a relatively wide width to the rear side having a relatively narrow width, and thus a rotation speed of the tornado is gradually decreased by resistance between the wind and an inner surface of the inlet portion 10, thereby changing from strong vortex wind to weakened wind.

The inlet portion 10 has a flange 12 of a desired width protruding from the lower end of the first opening 11, so that the inlet portion 10 can be fixed to the ground by fastening the flange 12 to the ground.

The flange 12 is formed with a plurality of through-holes 12a at regular intervals, so that the inlet portion 10 is simply fixed to the ground by inserting a fastening member 13 to the ground through the through-hole 12a.

The fastening member 13 may include any type of means which are configured to firmly fix the inlet portion 10 to the ground, such as an anchor bolt.

The first opening 11 is formed to have a size of 10 to 20 m in width and 4 to 8 m in length, or may be formed to have a size of 15 m in width and 6 m in length.

If the first opening 11 has a size of less than 10 m in width or less than 4 m in length, a lower portion of the tornado T moving along the ground cannot smoothly move into the first opening 11. If the first opening 11 has a size of more than 20 m in width or more than 8 m in length, the inlet portion 10 having the first opening 11 becomes larger, which is hard to be moved or installed. Therefore, the first opening 11 is preferably formed to have the size of 10 to 20 m in width and 4 to 8 m in length.

The inlet portion 10 is formed to have a length l1 of 6 to 12 m from the front end to the rear end, or may be formed to have a length l1 of 9.5 m from the front end to the rear end.

If the inlet portion 10 is formed to have the length l1 of less than 6 m from the front end to the rear end, a time of the tornado T entering the first opening 11 through the inlet portion 10 is shortened, an effect of dissipating the tornado T is reduced. If the inlet portion 10 is formed to have the length l1 of more than 12 m from the front end to the rear end, the inlet portion 10 becomes larger, which is hard to be moved or installed. Therefore, the inlet portion 10 is preferably formed to have the length l1 of 6 to 12 m from the front end to the rear end.

The inlet portion 10 may have a protrusion 14 protruding from an inner surface thereof.

When the tornado T entering the first opening 11 comes into contact with the protrusion 14, the rotation speed is gradually decreased by resistance between the tornado and the protrusion.

The protrusion 14 may be provided in plural along a longitudinal direction at regular intervals.

The rotation speed of the tornado T entering the first opening 11 is remarkably decreased by the resistance generated when the tornado sequentially passes the protrusions 14.

The protrusions 14 may be formed in such a way that each protruding height is gradually increased from the front side to the rear side.

The tornado T entering the first opening 11 comes into contact with all of the protrusions 14.

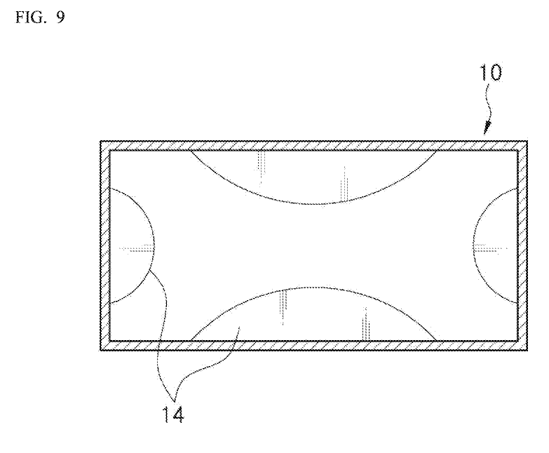

The protrusion 14 may be formed in any shape if it can apply contact resistance to the tornado T. For example, the protrusion 14 may be formed in a rectangular shape, or may be formed in an arc shape, as illustrated in FIG. 9.

The inlet portion 10 is made of metal, for example, a steel plate, so that the inlet portion is hard and very heavy, thereby preventing the inlet portion from being damaged when the inlet portion comes into contact with the tornado T.

The outlet portion 20 is formed in such a way that a width thereof consistently extends from the rear end of the inlet portion 10, and is inclined upwardly toward a rear side. The outlet portion 20 is provided at a rear end thereof with a second opening 21 which communicates with the first opening 11 and an exterior.

After the tornado T enters the first opening 11, the tornado is weakened through the inlet portion 10, and then is discharged through the second opening 21.

The outlet portion 20 is formed at an angle of 40 to 50 degrees to the ground, or may be formed at an angle of 45 degrees to the ground.

If the outlet portion 20 is formed at an angle of less than 40 degrees to the ground, the wind discharged through the second opening 21 may impact on facilities or people on the ground to cause them damage. If the outlet portion 20 is formed at an angle of more than 50 degrees to the ground, since the outlet portion 20 is sharply bent, movement of the tornado T from the inlet portion 10 to the outlet portion 20 may be interrupted. Therefore, the outlet portion 20 is preferably formed at the angle of 40 to 50 degrees to the ground.

The second opening 21 is formed to have a size of 3 to 7 m in width and 2 to 4 m in length, or may be formed to have a size of 5 m in width and 3 m in length.

If the second opening 21 has the size of less than 3 m in width or less than 2 m in length, the discharge of the weakened tornado T from the second opening 21 will be delayed. If the second opening 21 has a size of more than 7 m in width or more than 4 m in length, the outlet portion 20 having the second opening 21 becomes larger, which is hard to be moved or installed.

Therefore, the second opening 21 is preferably formed to have the size of 3 to 7 m in width and 2 to 4 m in length.

The outlet portion 20 is formed to have a length l2 of 6 to 10 m from the front end to the rear end, or may be formed to have a length l2 of 8 m from the front end to the rear end.

If the outlet portion 20 is formed to have the length l2 of less than 6 m from the front end to the rear end, a time of the tornado T passing through the outlet portion 20 is shortened, an effect of dissipating the tornado T is reduced. If the outlet portion 20 is formed to have the length l2 of more than 10 m from the front end to the rear end, the outlet portion 20 becomes larger, which is hard to be moved or installed. Therefore, the outlet portion 20 is preferably formed to have the length l2 of 6 to 10 m from the front end to the rear end.

The outlet portion 20 may have a protrusion 22 protruding from an inner surface thereof.

When the tornado T traveling from the inlet portion 10 to the outlet portion 20 comes into contact with the protrusion 22, the rotation speed is gradually decreased by resistance between the tornado and the protrusion.

The protrusion 22 may be provided in plural along a longitudinal direction at regular intervals.

The rotation speed of the tornado T traveling from the inlet portion 10 is further decreased by the resistance generated when the tornado sequentially passes the protrusions 22.

The protrusions 22 may be formed in such a way that each protruding height is gradually increased from the front side to the rear side.

The tornado T traveling from the inlet portion 10 to the outlet portion 20 comes into contact with all of the protrusions 22.

The protrusion 22 may be formed in any shape if it can apply contact resistance to the tornado T. For example, the protrusion 22 may be formed in a rectangular shape, or may be formed in an arc shape, as illustrated in FIG. 9.

The outlet portion 20 is made of metal, for example, a steel plate, so that the outlet portion is hard and very heavy, thereby preventing the outlet portion from being damaged when the outlet portion comes into contact with the tornado T.

The outlet portion 20 is made integrally with the inlet portion 10 to prevent the outlet portion 20 from being released from the inlet portion 10.

The operation of dissipating the tornado T by the tornado dissipating device A according to the embodiment will now be described in detail.

The tornado dissipating device A according to the embodiment is installed on an expected travel route of the tornado T.

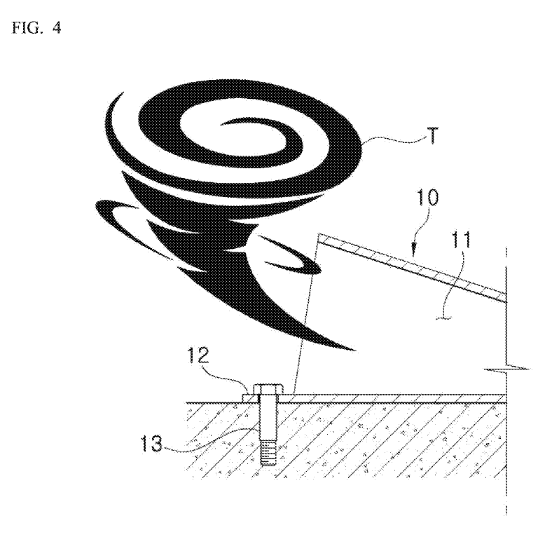

Since the first opening 11 of the inlet portion 10 is installed in a direction opposite to the tornado T, if the tornado T moves along the expected travel route, as illustrated in FIG. 4, the lower portion of the tornado enters the first opening 11.

The upper portion of the tornado T moves along the lower portion thereof that is continuously extended to the lower portion. Therefore, if the lower portion of the tornado T enters the first opening 11, the upper portion extended to the lower portion also enters naturally the first opening 11.

If the tornado dissipating device A according to the embodiment is moved due to the shock applied by the tornado T, the inflow of the tornado T into the first opening 11 may be difficult.

The inlet portion 10 has the flange 12 of a desired width protruding from the lower end of the first opening 11, and the flange 12 has the plurality of through-holes 12a.

As illustrated in FIG. 3, the tornado dissipating device A according to the embodiment is firmly fixed to the ground by inserting the fastening members 13, such as anchor bolts, to the ground through the through-holes 12a, it is possible to prevent the tornado dissipating device from being moved to the approach of the tornado T. Therefore, the tornado T can smoothly enter the first opening 11.

The inlet portion 10 is formed in such a way that the width is gradually decreased from the front side to the rear side.

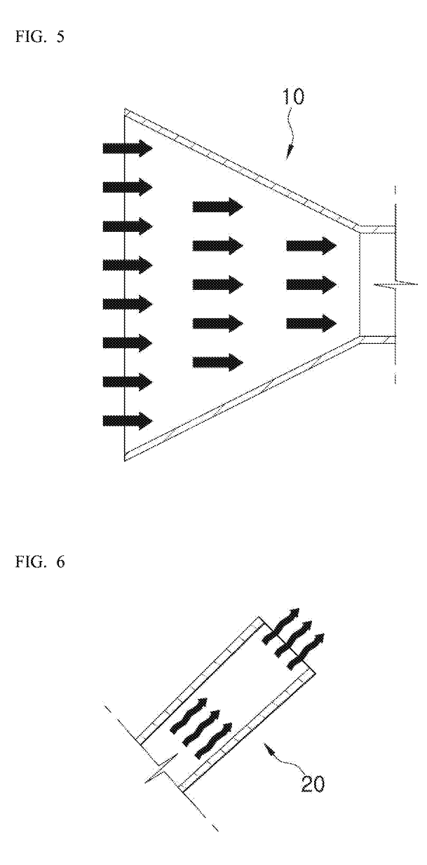

Due to the shape characteristic of the inlet portion 10, when the tornado T entering the first opening 11 comes into contact with the inner surface of the inlet portion 10 while moving from the front to the rear, as illustrated in FIG. 5, the resistance is produced by the contact, and thus the rotation speed is gradually decreased. Accordingly, the tornado T is dissipated (the figure shows that the number of arrows in the inlet portion corresponds to the strength of the tornado).

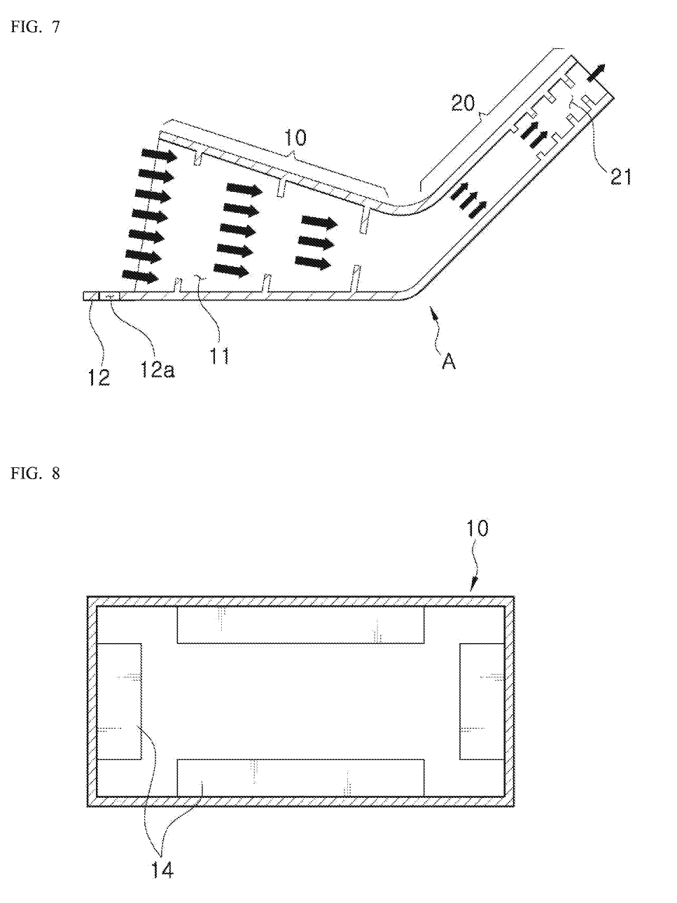

As described above, the inlet portion 10 may have the protrusion 14 protruding from the inner surface thereof, as illustrated in FIG. 7.

When the tornado T entering the first opening 11 comes into contact with the protrusion 14, the rotation speed is gradually decreased by the resistance between the tornado and the protrusion, and thus the tornado T is gradually dissipated.

The protrusion 14 may be provided in plural along the longitudinal direction at regular intervals.

The rotation speed of the tornado T entering the first opening 11 is remarkably decreased by the resistance generated when the tornado sequentially passes the protrusions 14, so that the tornado T is further dissipated.

Meanwhile, the protrusions 14 may be formed in such a way that each protruding height is gradually increased from the front side to the rear side.

The tornado T entering the first opening 11 comes into contact with all of the protrusions 14, so that the tornado T is further dissipated.

The tornado dissipating device according to the embodiment includes the outlet portion 20 having the second opening 21 at the rear of the inlet portion 10.

The tornado T is dissipated in the process of passing the first opening 11, as illustrated in FIG. 6, the rotation speed is decreased from the strong vortex wind to the dissipated wind (although it is relatively strong wind, its rotation speed is decreased, and thus it is no more strong vortex wind). After that, the wind is discharged through the second opening 21.

As described above, the outlet portion 20 may have a protrusion 22 protruding from the inner surface thereof, as illustrated in FIG. 7.

When the tornado T traveling from the inlet portion 10 to the outlet portion 20 comes into contact with the protrusion 22, the rotation speed is gradually decreased by the resistance between the tornado and the protrusion, so that the tornado T is further dissipated.

The protrusion 22 may be provided in plural along the longitudinal direction at regular intervals.

The rotation speed of the tornado T traveling from the inlet portion 10 to the outlet portion 20 is further decreased by the resistance generated when the tornado sequentially passes the protrusions 22, so that the tornado T is further dissipated.

The protrusions 22 may be formed in such a way that each protruding height is gradually increased from the front side to the rear side.

The tornado T traveling from the inlet portion 10 to the outlet portion 20 comes into contact with all of the protrusions 22, so that the tornado T is further dissipated.

Since the wind discharged through the second opening is relatively strong wind even though it is the dissipated wind, it may impact on facilities or people on the ground to cause them damage.

According to the embodiment, the outlet portion 20 is formed so as to be gradually inclined in an upward direction.

Since the wind discharged from the second opening 21 does not face the ground, but faces the sky, it is possible to prevent human injuries or material damages.

If the tornado T deviates from the expected travel route, it cannot expect that the tornado T is dissipated by the tornado dissipating device A according to the embodiment.

Therefore, it is preferable to expect the travel route in view of a previous travel route of the tornado T which has been figured out by a highly reliable equipment, such as a weather radar, GPS, or a super computer.

It is preferable to install several tornado dissipating devices A according to the embodiment side by side to the expected travel route of the tornado T, since there is an error in calculating the determination of the travel route of the tornado T.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A tornado dissipating device comprising:
an inlet portion that is formed in such a way that a width is gradually reduced from a front side to a rear side, and has at a front end thereof a first opening which communicates with an exterior; and
an outlet portion of constant width that is formed to be extended from the rear side of the inlet portion and be gradually inclined in an upward direction toward a rear side, and has at a rear end thereof a second opening which communicates with the first opening and an exterior.

2. The tornado dissipating device according to claim 1, wherein the inlet portion has a flange of a given width protruding from the lower end of the first opening.

3. The tornado dissipating device according to claim 2, wherein the flange has a plurality of through-holes formed at regular intervals.

4. The tornado dissipating device according to claim 1, wherein the first opening is formed to have a size of 10 to 20 m in width and 4 to 8 m in length.

5. The tornado dissipating device according to claim 1, wherein the inlet portion is formed to have a size of 6 to 12 m in length from the front end of the inlet portion to a rear end thereof.

6. The tornado dissipating device according to claim 1, wherein the outlet portion is formed at an angle of 40 to 50 degrees to the ground.

7. The tornado dissipating device according to claim 1, wherein the second opening is formed to have a size of 3 to 7 m in width and 2 to 4 m in length.

8. The tornado dissipating device according to claim 1, wherein the outlet portion is formed to have a size of 6 to 10 m in length from the front end to the rear end.

9. The tornado dissipating device according to claim 1, wherein the inlet portion and the outlet portion are respectively provided with a protrusion protruding from an inner surface thereof.

10. The tornado dissipating device according to claim 9, wherein the protrusion is provided in plural in a longitudinal direction of the tornado dissipating device at regular intervals.

11. The tornado dissipating device according to claim 10, wherein the plurality of protrusions is formed in such a way that a protruding height is gradually increased from the front side to the rear side of the inlet and outlet portions.

12. The tornado dissipating device according to claim 1, wherein the inlet portion and the outlet portion are made of metal.

13. The tornado dissipating device according to claim 12, wherein the inlet portion and the outlet portion are formed integrally with each other.
